(19) United States
(12) Patent Application Publication
(10) Pub. No.: US 2020/0248479 A1
(43) Pub. Date: Aug. 6, 2020

(54) DEVICE OF WIRELESS CONTROLLING A LOCK AND A METHOD OF PREVENTING UNLOCKING FROM OUTER SIDE

(71) Applicant: XIAMEN AEROLITE TECHNOLOGY CO., LTD., Xiamen City, Fujian (CN)

(72) Inventors: Siliang YI, Xiamen City, Fujian (CN); Xiaoyu Zhuang, Xiamen City, Fujian (CN); Zhimeng Xu, Xiamen City, Fujian (CN)

(73) Assignee: XIAMEN AEROLITE TECHNOLOGY CO., LTD., Xiamen City, Fujian (CN)

(21) Appl. No.: 15/770,012

(22) PCT Filed: Oct. 20, 2016
(86) PCT No.: PCT/CN2016/102702

§ 371 Date: Apr. 20, 2018

(30) Foreign Application Priority Data
Oct. 20, 2015 (CN) 201510682868.9
Oct. 20, 2015 (CN) 201510682870.6
Dec. 30, 2015 (CN) 201511023916.X
Jun. 17, 2016 (CN) 201610439536.2

(51) Int. Cl. E05B 47/00; E05B 15/00; G07C 9/00

(52) U.S. Cl. CPC E05B 47/0012; E05B 15/0033; E05B 2047/0091; E05B 2047/0067; E05B 2047/002; G07C 9/00182

(57) ABSTRACT

Disclosed is a device of wireless controlling a lock, which comprises a main body, the main body comprises: an open unit (1010), one end of the open unit (1010) is inserted to a key hole at the side of the door lock faced to the locked space and is disposed at an initial position; the initial position is a position when the open unit is inserted to the key hole; a driving unit (1020), the driving unit (1020) is linked to the open unit (10100) to drive the insert end of the open unit (1010) to rotate in the key hole; a start unit, the start unit is wireless connected to the driving unit, the start unit transmits control signal to make the driving unit drive the insert end of the open unit to rotate. The present invention further discloses a method of preventing unlocking from outer side

### TECHNICAL FIELD

The present invention relates to a unlocking mechanism and a method of preventing unlocking from outer side.

### RELATED ART

With the rise of the concept of smart home, more and more home supplies are electronized and intelligentized. Detailed in the lock aspect, to release the disadvantage of carry-on key, fingerprint locks are developing in the recent years. The user can use their unique fingerprint to unlock the lock but not the key. The fingerprint unlocking way is convenient and fast with high security. However, the fingerprint lock costs high, and it can not assemble to the original lock, the user has to change the door lock. The high costs stop people's feet. So if there is a technique that can wireless operate the older door lock and eliminate the trouble of key carrying, the cost can be reduced to benefit more people.

### SUMMARY OF THE INVENTION

The present invention is mainly provided with a device of wireless controlling a lock that the user can wireless unlock the door lock without the key. The mechanism can be widely used in various door lock, and the door lock needn't to be changed.

The present invention is further provided with a device of wireless controlling a lock that the user can record the motions of unlocking and locking by the App in the smart device. The unlocking command or locking command can be accurately sent out by operating the App.

The present invention is further provided with a device of wireless controlling a lock that the device inserted to the lock hole can be reset to the initial position after finishing the unlocking or locking motion.

The present invention is further provided with a device of wireless controlling a lock that a reset unit can be used to manually insert the device of the lock hole after a part of the device is pushed out.

To solve above mentioned problems, the present invention is provided with a device of wireless controlling a lock, which comprises:
an open unit, one end of the open unit is inserted to a key hole at the side of the door lock faced to the locked space and is disposed at an initial position; the initial position is a position when the open unit is inserted to the key hole;
a driving unit, the driving unit is linked to the open unit to drive the insert end of the open unit to rotate in the key hole;
a start unit, the start unit is wireless connected to the driving unit, the start unit transmits control signal to make the driving unit drive the insert end of the open unit to rotate;
the insert end of the open unit rotates in clockwise direction or in counter-clockwise direction under the driving of the driving unit.

In another preferred embodiment, further comprising a mechanical rotating unit and a motion record unit, the motion record unit records the forwardly rotating or backwardly rotating of the mechanical rotating unit to control the open unit to lock or unlock correspondingly by the driving unit.

In another preferred embodiment, the position calibrating device comprises a rotating element, a target position detection unit keeping still relative to the rotating element, an induction unit linked to the rotating element and a position control unit; when the rotating element is located at the target position, the detection unit and the induction unit couple to send indication signal out;
the position control unit outputs a first position driving current to the rotating element to drive the rotating element to rotate and position; when the response unit and the induction unit coupled to send an indication signal out, the first position driving current is cut off;
if the induction unit does not continuously send the signal out after the first position driving current is cut off, the position control unit outputs a second position driving current to the rotating unit, the second position driving current is reverse to the first position driving current, and the absolute value of the second position driving current is lower than that of the first position driving current; when the detection unit and the induction unit couple to send an indication signal out, the second position driving current is cut off;
if the induction unit does not continuously send the indication signal out after the second position driving current is cut off, the position control unit outputs a third position driving current to the rotating element; the third position driving current is reverse to the first position driving current, the absolute value of the third position driving current is lower than that of the second position driving current; when the response unit and the induction unit couple to send an indication signal out, the third position driving current is cut off;
and so forth, the induction unit sends a continuous indication signal out until a N position driving unit is cut off.

The present invention is further provided with a method of preventing unlocking from the outer side.

To solve above mentioned problem, the present invention is provided with a method of preventing unlocking from the outer side:

A rotating element: comprising an open unit, one end of the open unit is inserted to the lock hole of the door lock at the side facing to the locked space and is located at an initial position; the initial position is the position the open unit inserted to the lock hole; a driving unit, the driving unit is linked to the open unit to drive the insert end of the open unit to rotate in the lock hole;
a start unit, the start unit is wireless controlled to the driving unit, the start unit transmits a control signal to make the drive unit drive the insert end of the open unit to rotate.
the rotating element receives a burglary resistant command, the rotating element is controlled to rotate to a lock angle besides the unlocking angle and the locking angle.

In another preferred embodiment, the rotating element rotates towards the commanded direction after received a unlocking command or a locking command to make the door lock located in unlocking state or locking state; the rotating element rotates in a corresponding direction to be located at the lock angle besides the unlocking angle and the locking angle after received a burglary resistant command

Compared to the existing known technology, the present invention has following advantages:
1. The present invention is provided with a device of wireless controlling a lock that a key spindle is inserted to the lock hole at the side of the traditional lock door facing the locked space, the App wireless controls the key spindle to rotate in the clockwise direction or counter-clockwise direction to achieve wireless unlocking or locking. Therefore, the preset invention is provided with a wireless unlocking or locking mechanism that it needn't change the structure of the traditional door lock nor replacing by a new door lock to achieve the wireless locking or unlocking functions. The usage is simple and fast, the assembly is also simple and convenient.
2. The present invention is provided that the forward rotation and the reverse rotation are taken in mechanical way before the usage, and the rotating track of the open unit under the two motions are recorded and correspond to the corresponding commands of the start unit. After that, the user can make the key spindle rotate forwardly or reversely by the App to operate the unlocking or locking.
3. The present invention is provided that three Hall sensors are coupled to the magnet, the order of the Hall sensors sending the induction signal out is recorded, namely recording the rotating track of the key spindle. By the conduction of different Hall sensors, the forward rotation and the reverse rotation of the key are separated. The structure is simple, the components are less and the record is accurate. After the forward rotation and the reverse rotation of the key are defined, the user can send the forward rotation or reverse rotation command by the App of the phone, so the open unit can rotate forwardly or reversely in the lock hole to the end to achieve locking or unlocking.
4. The present invention is provided that after the key spindle finishes its locking or unlocking motion, the key spindle is rotated reversely to the initial position, that is to say, the key spindle is always located at the initial position after the unlocking or locking motion. So the user can insert the key to the key hole at the side facing the open space and push the key spindle out thus to use the traditional key to mechanically unlock. So the user can still use the traditional key to open the door even in an accident of electrical fault or power off.
5. The present invention is provided with an initial position indication unit, which comprises a photoelectricity generation mechanism; when the key spindle rotates reversely until the photoelectricity generation mechanism sends an optical signal out, the App judges that the key spindle is located at the initial position and sends a control signal to make the key spindle stop rotating.
6. The initial position indication unit of the present invention further comprises an initial position calibrating mechanism. When the wireless unlocking or locking mechanism is assembled, the key spindle is limited in the initial position by the lock hole, the photoelectricity generation mechanism can not be accurately located at the initial position due to deviation. The initial position calibrating mechanism can change the relative position of the photoelectricity generation mechanism and the gap, the photoelectricity generation mechanism is not located at the initial position unless the mechanism sends an indication signal out.
7. The present invention further comprises a reset mechanism. When the key spindle is partially pushed out of the key hole, the reset mechanism is operated to make the key spindle inserted to the key hole again. So the mechanism needn't to be disassembled and re-assembled.
8. The present invention is provided with a method of preventing unlocking from the outer side, the key is inserted from the inner side, the angle of the inner side of the key is located at a not-pulled out angle, making the key unable to be inserted form the outer side, so the lock can not be unlocked from the outer side. By remote method, in unlocking state or locking state, the lock is locked up to prevent a risk of trespass from the outer side. The present invention keeps the locking and unlocking function by an internal key and an external key that it is convenient and safe.

### BRIEF DESCRIPTION OF THE DRAWINGS

FIG. 1 illustrates a schematic diagram of a device of wireless controlling a lock of a first embodiment of the present invention.

FIG. 2 illustrates an exploded diagram of the device of wireless controlling a lock of the first embodiment of the present invention.

FIG. 3 illustrates an exploded diagram of the parts of the device of the first embodiment of the present invention.

FIG. 4 illustrates a sectional diagram of the device of the first embodiment of the present invention.

FIG. 5 illustrates another sectional diagram of the device of the first embodiment of the present invention.

FIG. 6 illustrates an exploded diagram of the device of the second embodiment of the present invention.

FIG. 7 illustrates a side view of the device of the second embodiment of the present invention.

FIG. 8 illustrates a partially sectional diagram of the device of the second embodiment of the present invention.

FIG. 9 illustrates a partially schematic diagram of the device of the second embodiment of the present invention.

FIG. 10 illustrates another partially schematic diagram of the device of the second embodiment of the present invention.

FIG. 11 illustrates a partially exploded diagram of the device of the present invention.

### DETAILED DESCRIPTION OF THE EMBODIMENTS

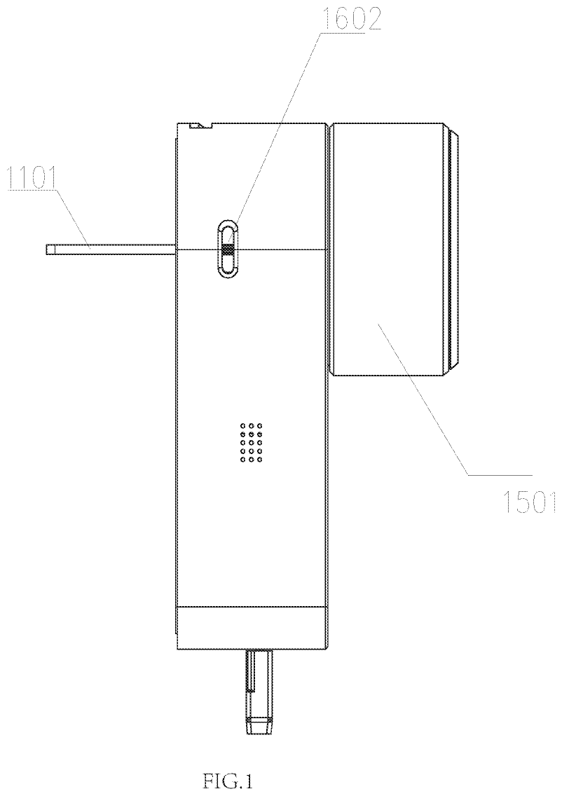

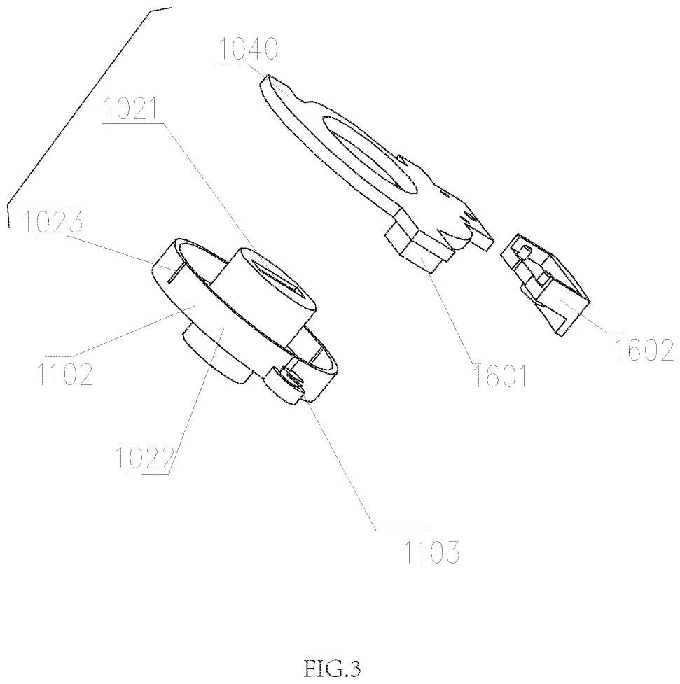

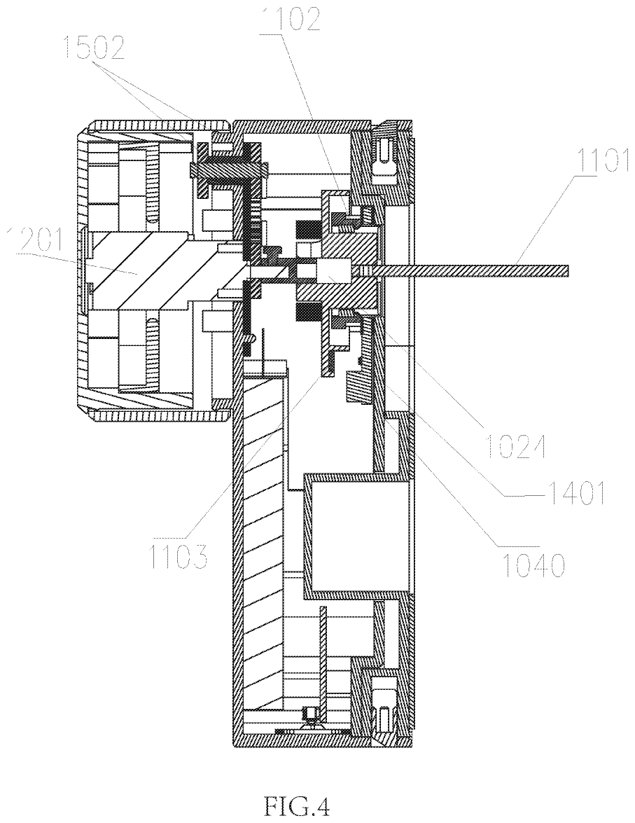

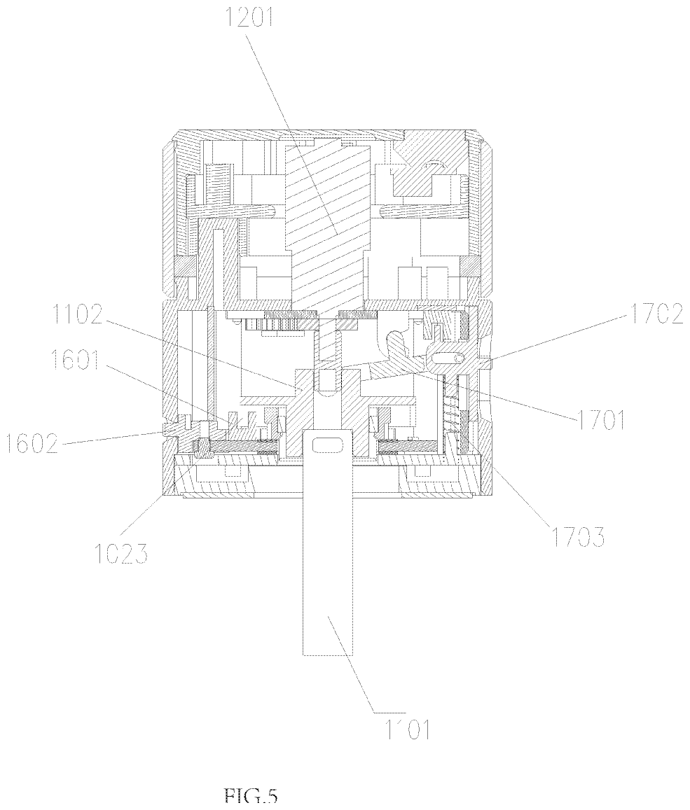

The first embodiment: referring to FIGS. 1-5, a device of wireless controlling a lock comprises:
an open unit 1010, one end of the open unit 1010 is inserted to a key hole at the side of the door lock faced to the locked space and is disposed at an initial position; the initial position is a position when the open unit 1010 is inserted to the key hole;
a driving unit 1020, the driving unit 1020 is linked to the open unit 1010 to drive the insert end of the open unit 1010 to rotate in the key hole;
a start unit, the start unit is wireless connected to the driving unit 1020. In this embodiment, the start unit is wireless controlled to the driving unit 1020 by Bluetooth or WiFi. The start unit transmits control signal to make the driving unit 1020 drive the insert end of the open unit 1010 to rotate.

In this embodiment, the open unit 1010 comprises a key spindle 1101 and a rotating plate 1102 coaxially rotatable; one end of the key spindle 1101 is the insert end, the other end is disposed with a first insert hole 1021 at the center of circle of the front side of the rotating plate 1102. The user can choose corresponding size of key spindle 1101 according to his lock type, and then polish the same key hole or key groove with the original key in the key spindle 1101. Therefore, above wireless locking or unlocking mechanism is provided that the open unit 1010 is inserted to the key hole at the side of the traditional door lock facing the locked space and a start unit is used to wireless control the open unit 1010 to rotate in the key hole to achieve wireless unlocking or locking. In essence, the unlocking is achieved by rotating a key. But the portion of driving the key to rotate is changed from traditional manual control to the driving unit 101 wireless controlled by the start unit. Therefore, the wireless locking or unlocking mechanism doesn't need to change the traditional door lock nor force to change a new door lock. The usage is simple and fast, and the assembly is simple and convenient.

To achieve unlocking or locking, the key spindle 1101 rotates forwards or reversely by the driving of the driving unit 1020, therein, the forward rotation is defined unlocking, and the reverse rotation is defined locking.

To achieve above motion, the mechanism further comprises a motion record unit 1040, the motion record unit 1040 records the rotation track of the key spindle 1101. Detailed, the motion record unit 1040 comprises three Hall sensors 1401 arranged on the same plane and distributed of 120° and a magnet 1103 linked to the key spindle 1101; in this embodiment ,when the magnet 1103 is disposed at the external periphery of the rotating plate 1102 and is parallel to the motion record unit 1040.

When the key spindle 1101 rotates, the magnet 1103 faces to the three Hall sensors 1401 in order to make the sensors transmit sensing signals, recording the order of the Hall sensors 1401 transmitting sensing signals is recording the rotating trajectory of the key spindle 1101.

And a mechanical rotating unit 1050, the mechanical rotating unit 1050 is operated to drive the rotating plate 1102 to rotate so as to drive the key spindle 1101 to coaxially rotate. When the mechanism rotating unit 1050 is operated to drive the key spindle 1101 to rotate, the start unit records the order of the three Hall sensors 1401 transmitting the sensing signals, different motions corresponds to different operation of the start unit.

Namely, after the user assembles the device of wireless controlling a lock, he needs to define the motion of forward rotation and reverse rotation. The mechanical rotating unit 1050 is operated one time to unlock and one time to lock respectively. Each motion provides part or all of the three Hall sensors 1401 to transmit sensing signals, the order of the Hall sensors 1401 transmitting signal in different motions is recorded and the order corresponds to the operation of the start unit, so the start unit sends forward rotation or reverse rotation commands to the key spindle 1101 to control the driving unit 1020 to drive the key spindle 1101 to rotate forwardly or rotate reversely to accomplish unlocking or locking. When the key spindle 1101 rotates forwardly or reversely to the end and keeps for seconds, the judgment of forward rotation or reverse rotation is finished. Therefore, when the key spindle 1101 rotates forwardly or reversely to the end, the driving unit 1020 doesn't drive the key spindle 1101 to keep rotating forwardly or reversely that avoids the driving unit 1020 from continuously driving the key spindle 1101 to rotate that leads the key hole from damage by the key spindle 1101.

In this embodiment, the mechanical rotating unit 1050 comprises a hand wheel 1501 and a gear driving mechanism 1502, the gear driving mechanism 1502 achieves the synchronously rotating of the rotating plate 1102 and the hand wheel 1501. The detailed combination and distribution of the gear driving mechanism 1502 are traditional designation in the mechanical field that it will not be further described hereafter.

Above mention device of wireless controlling a lock is driven by electrical signal. It is unavoidable that the user can not lock or unlock the lock by wireless method due to power off or software fault of the start unit. As the existing door lock has lock holes at two sides, when the lock hole is located at the initial position, if the key is inserted to the key hole at one side, the key at the other key hole can be pushed out. The closing condition of the motion is that the key hole and the key inserted at the key hole are located in the initial state.

Therefore, after the key spindle 1101 finishes its locking or unlocking motion, the key spindle is rotated reversely to the initial position, that is to say, the key spindle 1101 is always located at the initial position after the unlocking or locking motion. So the user can insert the key to the key hole at the side facing the open space and push the key spindle 1101 out thus to use the traditional key to mechanically unlock. So the user can still use the traditional key to open the door even in an accident of electrical fault or power off.

To achieve the function, the device of wireless controlling a lock further comprises an initial position indication unit 1060 which indicates when the key spindle 1101 is located at the initial position. The start unit controls the key spindle 1101 to stop rotating reversely after received the indication signal.

The initial position indication unit 1060 comprises a photoelectricity generation device 1601 oppositely arranged, if no block is between the photoelectricity generation device, the photoelectricity generation device transmits an indication signal.

The edge of the rotating plate 1102 is disposed with a surrounding portion 1022 extending along the rotating shaft, the photoelectricity generation device 1601 is disposed at the interior and external sides of the surrounding portion 1022; the surrounding portion 1022 is disposed with a gap 1023; when the key spindle 1101 is not located at the initial position, the photoelectricity generation device 1601 is blocked by the surrounding portion 1022; when the key spindle 1101 is located at the initial position, the photoelectricity generation device 1601 is connected by the gap 1023. So only when the key spindle 1101 is located at the initial position, the photoelectricity generation device 1601 sends an optical indication signal out,

In this embodiment, there are two gaps 1023 distributed at an angle of 180°. So no matter the key spindle 1101 rotates reversely in the clockwise direction or in the counter-clockwise direction, the photoelectricity generation device 1601 can detect when the key spindle 1101 returns to the initial position at the first time.

As the device of wireless controlling a lock has deviation unavoidably due to personal error, which makes the photoelectricity generation device 1601 not at the initial position, when the photoelectricity generation device 1601 sends an indication signal out, the key spindle is actually not at the initial position. To eliminate this error, the initial position indication unit 1060 further comprises an initial position calibration mechanism 1602; when the key spindle 1101 is inserted to the key hole, as the key spindle 1101 is restricted by the lock hole, the key spindle 1101 and the rotating plate 1102 are at the initial position. At this time, the initial position of the photoelectricity generation device 1602 is calibrated to the initial position by the initial position calibration mechanism changing the position of the photoelectricity generation device 1601 relative to the gap 1022 until the photoelectricity generation device 1602 sends an indication signal out.

In this embodiment, the initial position calibrating mechanism 1602 is a dial button linked to the photoelectricity generation device 1601, and the dial button is exposed out of the wireless unlocking or locking mechanism. The user needn't to open the housing of the mechanism to calibrate the initial position.

Furthermore, when the user uses a traditional key to push the key spindle 1101 out for mechanically unlocking at the other side of the door lock due to some reasons, if the wireless unlocking or locking function is needed to be used again, the key spindle 1101 is needed to be inserted to the key hole again. To accomplish above mentioned motion, the wireless unlocking or locking mechanism further comprises a resetting unit 1070, which is operated to make the key spindle 1101 inserted to the key hole again when the key spindle 1101 is partially pushed out.

Moreover, the resetting unit 1070 comprises a lever 1701; when a part of the key spindle 1101 is pushed out, one end of the lever 1701 is squeezed to move, the other end of the lever 1701 is linked to drive a dial button 1702 to move from a first position to a second position, when the dial button 1702 is dialed back to the first position by external force, the key spindle 1101 is inserted to the key hole again. To reduce the force dialing the dial button 1702, a spring 1703 is further provide; when the dial button 1702 moves from the first position to the second position, the spring 1703 is compressed to restore elastic potential energy; after the dial button 1702 is dialed, the dial button 1702 returns to the first position by the elastic resetting force.

In this embodiment, the driving unit 1020 comprises a motor 1201, a motor control circuit and a power mechanism 1202; the rotating shaft of the motor 1201 is inserted to a second insert hole 1024 at the center of circle at the back side of the rotating plate 1102; the motor control circuit receives the control signal from the start unit to control the motor 1201 to rotate forwardly or reversely.

The power mechanism 1202 is a lithium battery, which can be charged by an USB interface.

The open unit is an App installed in a personal smart device, and is wireless connected to the drive unit 1020 by Bluetooth or WiFi.

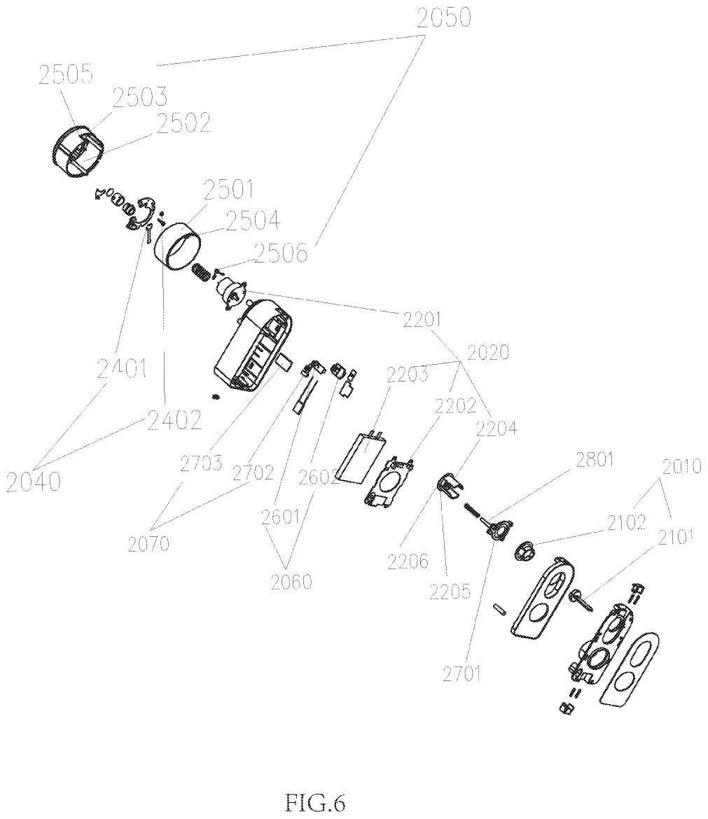

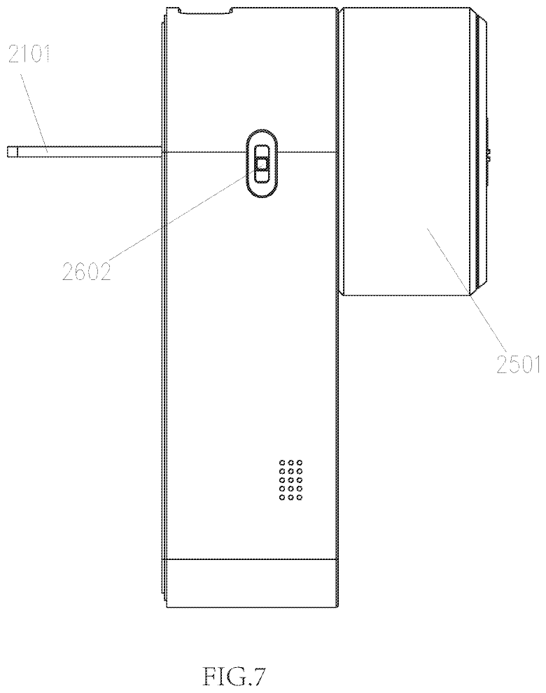

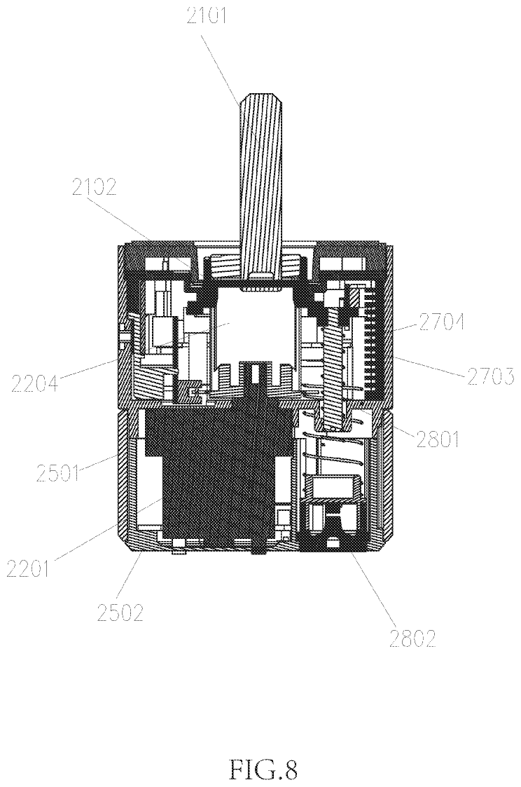

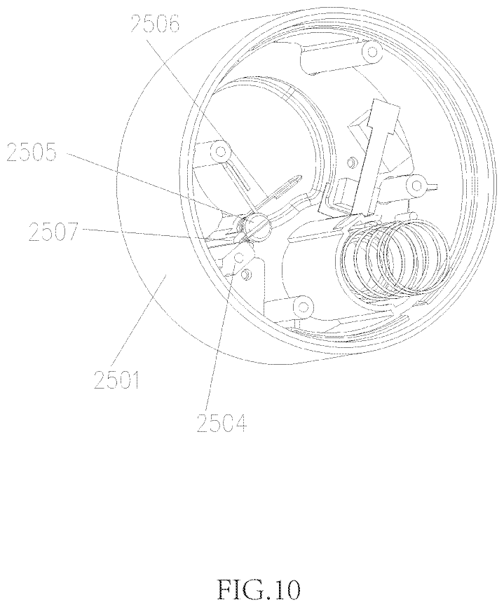

The second embodiment, referring to FIGS. 6-10, a device of wireless controlling a lock is the same as the first embodiment, the lock comprises a main body, which comprises:
an open unit 2010, a driving unit 2020 and a start unit. The start unit is wireless connected to the driving unit; the start unit transmits control signal to control the driving unit 2020 to drive the insert end of the open unit 2010 to rotate.

In this embodiment, the start unit 2010 comprises a key spindle 2101 and a key sleeve 2102 coaxially rotatable. One end of the key spindle 2101 is the insert end, the other end is inserted to the insert hole of the key sleeve 2102 to accomplish coaxial rotation. The user can user can choose corresponding size of key spindle 2101 according to his lock type, and then polish the same key hole or key groove with the original key in the key spindle 2101.

To achieve unlocking or locking, the key spindle 2101 rotates forwards or reversely by the driving of the driving unit 2201, therein, the forward rotation is defined unlocking, and the reverse rotation is defined locking.

To achieve above motion, the mechanism further comprises a mechanical rotating unit 2050 and a motion record unit 2040, the motion record unit 2040 records the forward rotation or the reverse rotation of the mechanical rotating unit 2050, so as to control the key spindle 2101 to rotate forwardly or rotate reversely correspondingly by the motor 2201. Detailed, the motion record unit 2040 comprises two Hall sensors 2401 and a magnet 2402 linked to the mechanical rotating unit 2050; when the mechanical rotating unit 2050 is operated to drive the magnet 2402 to rotate, the motion record unit 2040 records which Hall sensor 2402 is conducted in different motions, different motions corresponds to different operation of the start unit. After that, the user can just make the start unit to send corresponding operation commands to make the key spindle 2101 to rotate forwardly or reversely by the driving of the driving unit.

The mechanical rotating unit 2050 comprises a hand wheel 20501 and a hand wheel fixing base 20502; the hand wheel 2501 is sleeved on the hand wheel fixing base 2502 and is rotatable with respect to the hand wheel fixing base 2502; the Hall sensors 2401 are fixedly disposed in the hand wheel fixing base 2502; the external periphery of the hand wheel fixing base 2502 is disposed with a groove 2503, the internal periphery of the hand wheel 2501 is disposed with a limit rib 2504 at a position corresponding to the groove 2503, the bottom portion of the groove 2503 is disposed with the magnet 2402; the hand wheel fixing base 2502 is further disposed with a fixing shaft 2505, which is assembled with a torsion spring 2506, the side surface of the fixing shaft 2505 is disposed with a limit protruding trip 2507; when the hand wheel 2501 is located at the initial position, the limit protruding trip 2507 abuts against and limits the limit rib 2504.

By the arrangement, when the hand wheel 2501 is rotated, as the travel switch 2503 is fixedly hand wheel fixing base 2502, the magnet 2402 at the bottom portion of the limit rib 2504 rotates with respect to the Hall sensor 2401; when the hand wheel 2501 rotates in the clockwise direction, the magnet 2402 is opposite to the Hall sensor 2401 at the right side to make the Hall sensor 2401 inducted. When the hand wheel 2501 rotates in the counter-clockwise, the magnet 2402 is opposite to the Hall sensor 2401 at the left side to make the Hall sensor 2401 inducted. Making the induction order of the Hall sensors taking above two motions corresponds to the operation of the start operation can provide the user to just send corresponding operation commands in the start unit to make the key spindle 2101 rotate forwardly or reversely by the driving of the driving unit.

In addition, when the user is in the house, he can manually rotate the hand wheel 2501 to make different Hall sensor 2401 inducted to trigger the locking or unlocking command. When the user releases the hand wheel 2501, the hand wheel 2501 returns to the limit rib 2505 to abut against the limit protruding trip 2507 again under the action of the torsion spring 2506, thus achieving resetting.

Above mention device of wireless controlling a lock is driven by electrical signal. When there is a failure that the motor 2201 can not drive the open unit 2010 to rotate, the user needs to unlock by the traditional mechanical key. As the existing door lock has lock holes at two sides, when the lock hole is located at the initial position, if the key is inserted to the key hole at one side, the key at the other key hole can be pushed out. The closing condition of the motion is that the key hole and the key inserted at the key hole are located in the initial state.

Therefore, after the key spindle 2101 finishes its locking or unlocking motion, the key spindle is rotated reversely to the initial position, that is to say, the key spindle 2101 is always located at the initial position after the unlocking or locking motion. So the user can insert the key to the key hole at the side facing the open space and push the key spindle 2101 out thus to use the traditional key to mechanically unlock. So the user can still use the traditional key to open the door even in an accident of electrical fault or power off.

To achieve the function, the wireless locking or unlocking device further comprises an initial position indication unit 2060 which indicates when the key spindle 2101 is located at the initial position.

The initial position indication unit 2060 comprises a pair of photoelectricity generation devices oppositely arranged, if no block is between the photoelectricity generation devices, the photoelectricity generation device transmits an indication signal. The front end of the motor shaft sleeve 2204 is disposed with a hem 2205, the hem 2205 is disposed with two gaps 206 faced to the shaft axis of the motor shaft sleeve 2204 and arranged at an angle of 180°; when the key spindle 2101 is not located at the initial position, the first photoelectricity generation device 2601 is blocked by the hem 2205; when the key spindle 2101 is located at the initial position, the first photoelectricity generation device 2601 is connected by the gaps. Therefore, whether the key spindle 2101 is located at the initial position or not is judged by whether the first photoelectricity generation device 2601 sends an indication signal out.

In this embodiment, there are two gaps 2206 distributed at an angle of 180°. So no matter the key spindle 2101 rotates reversely in the clockwise direction or in the counter-clockwise direction, the photoelectricity generation device 2601 can detect when the key spindle 2101 returns to the initial position at the first time.

As the wireless locking or unlocking device has deviation unavoidably due to personal error, which makes the photoelectricity generation device 2601 not at the initial position, when the photoelectricity generation device 2601 sends an indication signal out, the key spindle is actually not at the initial position. To eliminate this error, the initial position indication unit 2060 further comprises an initial position calibration dial button 2602; when the key spindle 2101 is at the initial position, the initial position of the photoelectricity generation device 2602 is calibrated to the initial position by the initial position calibration dial button 2602 changing the position of the first photoelectricity generation device 2601 relative to the gap 2206 until the photoelectricity generation device 2601 sends an indication signal out.

It is such a trouble for the user to manually reset the key spindle to the initial position after each time of locking or unlocking. Therefore, the mechanism further comprises a reset unit; when key spindle 2101 is rotated forwardly or reversely to the end, the reset unit makes the key spindle 2101 rotate reversely to the initial position.

The reset unit comprises a PWM module to make the motor drive the key spindle 2101 to rotate and decelerate, the open unit stops rotating unit the first photoelectricity generation device 2601 sends an indication signal out. The PWM module reduces the rotating speed of the key spindle 2101 to ensure that the period of the gap 2206 passing through the first photoelectricity generation device 2601 is long enough and ensures the normal induction of the first photoelectricity generation device 2601.

The wireless locking or unlocking device can not normally work after the key spindle 2101 is pushed out. So the user needs to insert the key spindle 2101 to the key hole again. The device further comprises a push detection unit 2070; when the key spindle 2101 is pushed out, the push detection unit 2070 sends an indication signal out.

The push detection unit 2070 comprises a moving board 2701 linked to the open unit 2070; the moving board 2701 is fixedly dispose with a pair of second photoelectricity generation devices 7202 oppositely arranged; the main body is fixedly disposed with a detection trip 2703 perpendicularly passing through the second photoelectricity generation devices 2702, the detection trip 2703 is disposed with a plurality of grooves 7204 arranged with space; when the key spindle 2101 is pushed out, the second photoelectricity generation devices 2702 move towards the detection trip 2703 to make the second photoelectricity generation devices blocked by the spaces between the grooves 2704 and connected by the grooves 2704, the open unit is determined to be pushed out, the push detection unit 2070 alarms with sound and light to indicate.

To make it convenient for the user to insert the key spindle 2101 to the key hole again, the device further comprises a push reset unit with a push rod 2801 fixedly disposed at the moving board 2701, the end of the push rod 2801 is disposed with a reset button 2802; when the key spindle 2101 is pushed out, the moving board 2701 drives the push rod 2801 to push the reset button 2802 out. User can just press the reset button 2802 down, the key spindle 2101 is inserted to the key hole again.

This embodiment further comprises the preferred designations:

The power mechanism 1202 is a lithium battery, which can be charged by an USB interface.

The open unit is an App installed in a personal smart device, and is wireless connected to the drive unit 2020 by Bluetooth or WiFi.

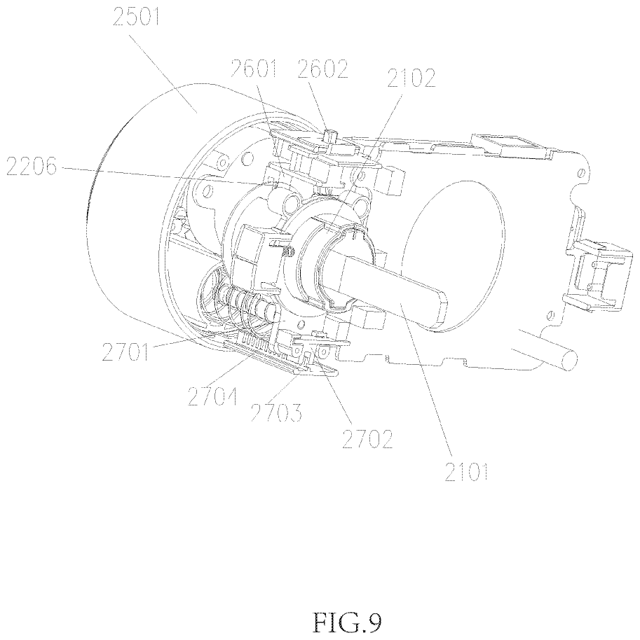

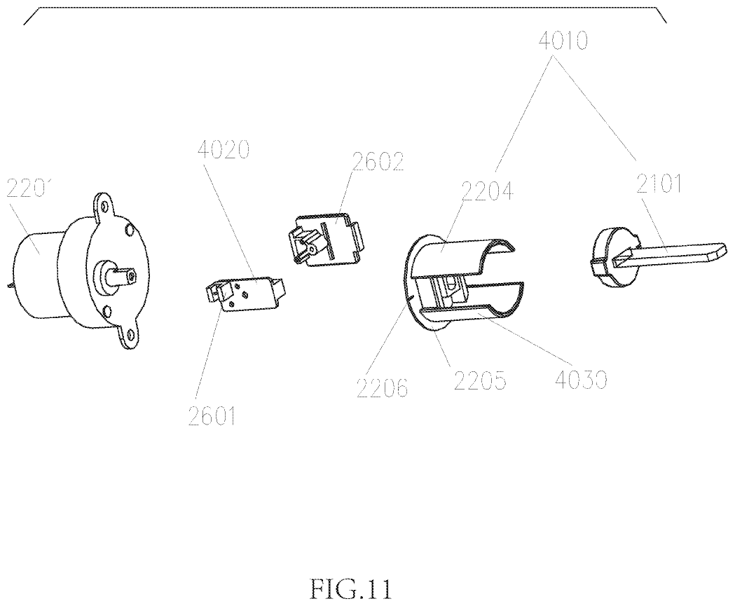

The third embodiment, referring to FIG. 9 and FIG. 11, the position calibrating device of the device of wireless controlling a lock comprises:
a rotating element 4010, comprising a key spindle 2101, a motor 2201, a motor shaft sleeve 2204; a detection unit 4020, which keeps still with respect to the rotating element 4010; an induction unit 4030, which is linked to the rotating element 4010, and a position control unit; when the rotating element is located at the target position, the detection unit 4020 and the induction unit 4030 couple to send indication signal out;
the position control unit outputs a first position driving current, a second position driving current, a N position driving current reverse in order and the absolute value thereof reduced in order, until the rotating element stops rotating, the detection unit and the induction unit couple to sends an indication signal out.

Detailed, the detection unit 4020 comprises a pair of photoelectricity generation devices 2601 oppositely arranged; if no block is between the photoelectricity generation devices 2601, the photoelectricity generation device transmits an indication signal. The key spindle 2101 is driven by a motor 2101, the output shaft of the motor 2101 drives the key 2103 to rotate by the motor shaft sleeve 2204.

The front end of the motor shaft sleeve 2204 is disposed with a hem 2205, the induction unit 4030 is two gaps 2206 disposed at the hem 2205, the two gaps 2206 are faced to the shaft axis of the motor shaft sleeve 2204 and arranged at an angle of 180°. The position of the gaps 2206 and the initial position of the key spindle 2101 are on the same plane.

With this configuration, when the key spindle 2101 is not located at the initial position, the photoelectricity generation device 2601 is blocked by the hem 2205; when the key spindle 2101 is located at the initial position, the photoelectricity generation device 2601 is connected by the gaps. So the user can just observe whether the photoelectricity generation device 2601 sends an optical signal out, he can know whether the key spindle 2101 is located at the initial position. So even the key is inserted at one side of the doo lock, a human at the other side can still insert the other key to push the original key out, thus avoiding from unlocking failure. In addition, this judgment result is very reliable.

When the key spindle 2101 is not at the initial position, the user can operate the position control unit to provide a first position driving current to the motor to make the motor rotate in a direction; when the photoelectricity device 2601 sends a sound-light indication, the position control unit cuts off the first position driving current. But as the motor 2201 has rotation inertia, the key spindle 2101 continuously rotates a certain angle; when the motor 2201 stops rotating, the key spindle 2101 deviates from the initial position; so when the motor 2201 stops rotating, the photoelectricity generation device 2601 does not send a sound-light indication out. At this time, the position control unit provides a second position driving current to the motor, the absolute value is lower than that of the first position driving current, and the directions are opposite. The motor 2201 rotates reversely. When the photoelectricity generation device 2601 sends a sound-light indication out, the position control unit cuts off the second position driving current . . . and so forth, the photoelectricity device 2601 sends continuous sound-light indication until the motor 2201 stops rotating. The key spindle 2101 is now accurately positioned.

The fourth embodiment: a method of preventing unlocking from outer side, comprising:
a rotating element 4010 for locking and unlocking is inserted to a lock hole at the interior of the door lock, the rotating element 4010 receives a burglary resistant command, the rotating element 4010 is controlled to rotate to a lock-up angle besides the unlocking angle and the locking angle. As a accomplishment method of controlling the rotating element 4010 to unlock and lock the lock, the commands can be sent by wireless communication methods such as Bluetooth. The rotating element 4010 receives the commands by a receiving device, the rotating element 4010 responses to the command and rotates. The commands are achieved by an APP installed in a smart device.

The unlocking angle and the locking angle can be arranged in a certain range. For example, the unlocking angle can be 90° ranged from the angle of the key relative to the plane when the key unlocks the lock spindle to the locking direction. The locking angle can be 90° ranged from the angle of the key relative to the plane when the key locks the lock spindle to the unlocking direction. The present invention is provided that the unlocking angle and the locking angle have certain of margin to avoid a failure of open the door from the outer side by a key due to mechanical error.

To make the method of the present invention available to all door lock operated by keys, the lock-up angle is between the unlocking angle and the locking angle. It is considered that the unlocking angle and the locking angle of part of door locks are their limit angle that rotation can no longer be taken. Therefore, when the rotating element 4010 is located at the unlocking angle, the rotating element 4010 rotates towards the locking direction; when the rotating element detection unit is located at the locking angle, the rotating element 4010 rotates towards the unlocking direction. That is to say, the rotating element 4010 is in the lock-up angle by rotating back a certain angle after the unlocking or the locking.

In this embodiment, the unlocking command, the locking command and the lock-up command can be individual. So from unlock to lock or from lock to unlock, there are two steps. That is to say, the rotating element 4010 rotates to the corresponding direction of the command to make the lock placed in the unlocking state or the locking state after received the unlocking command or the locking command; then the rotating element 4010 rotates in the corresponding direction to make the lock placed in the lock-up angle besides of the unlocking angle and the locking angle after received the burglar resistant command.

As a lock releasing method, when the rotating element 4010 is at the lock-up angle and receives a unlock command, the rotating element 4010 is reset to the angle at the last state. That is to say, if the current operation is first unlocking and then lock-up, the rotating element 4010 is reset to the unlocking angle after received the unlocking command; if the current operation is first locking and then lock-up, the rotating element 4010 is reset to the locking angle after received the unlocking command After that, a person can use a key to unlock or lock.

As another lock releasing method, when the rotating element 4010 is at the lock-up angle and receives a state switch command, the rotating element 4010 is reset to the angle at the next state with respect to the last state. That is to say, if the current operation is first unlocking and then lock-up, the rotating element 4010 rotates to the unlocking angle after received the state switch command; if the current operation is first locking and then lock-up, the rotating element 4010 rotates to the locking angle after received the state switch command.

The lock-up releasing method can be applied that:

If a person unlocks the door and gets in the house and lock-up the lock, when he wants to sleep or get out and unlock the door, the last state is the unlocking state, the next state is the locking state. The unlocking state is switched to locking state after received the state switch command, and the rotating element 4010 rotates to the lock-up angle again.

If a person locks the door and gets out of the house and lock-up the lock, when he wants to unlock the door and gets in, the last state is the locking state, the next state is the unlocking state. The unlocking state is switched to unlocking state after received the state switch command, and the rotating element 4010 rotates to the lock-up angle again.

To simplify the operation process, the unlocking command, the locking command can be continuously transmitted with the burglar resistant command. When the rotating element 4010 receives a locking command or a unlocking command and is located at the corresponding angle, the rotating element responses to the burglary resistant command automatically and executes corresponding to the burglary resistant command. If a person wants to unlock to get in the house, the rotating element 4010 is firstly situated in unlocking state, then in lock-up state, but at this time, the lock is unlocked, the rotating element 4010 is in lock-up state, the door can be open without influence. If a person wants to get out the house and lock, the rotating element 4010 is firstly in the locking state, then in the lock-up state, but at this time, the door is closed, the lock is locked, the rotating element 4010 is in the lock-up state, the door can be closed without influence.

The structure of the rotating element 4010 can be the driving unit and the open unit in the second embodiment, it comprises a key spindle 2101, a motor 2201, a motor shaft sleeve 2204, as figured in FIG. 9 and FIG. 11. A lock position is added to the driving unit, the start unit is further disposed with a burglar resistant command.

The rotating element 4010 of this embodiment is assembled to an existing door lock, the motor 2201 of the driving unit thereof controls the key spindle 2101 of the open unit. The rotating element 4010 is judged to be located at the unlocking angle, the locking angle or the lock-up angle by detecting the angle of the internal key spindle 2101.

To detect the internal key spindle 2101, the rotating element 4010 is judged to be located at the unlocking angle, the locking angle or the lock-up angle by detecting the absolute angle of the internal key spindle 2101 or the relative angle with the unlocking angle and locking angle after rotated.

The absolute angle takes the horizontal angle for reference and combines with the character of the current door lock (for example, the unlocking angle is horizontal, the locking angle is the horizontal angle after two rounds of rotating), the initial angel of the internal key spindle 2101 is the start angle, the rotating angle of the internal key spindle 2101 is the absolute angle.

The relative angle is a difference of the angle of the key 12 after rotated to the start angle of the internal key.

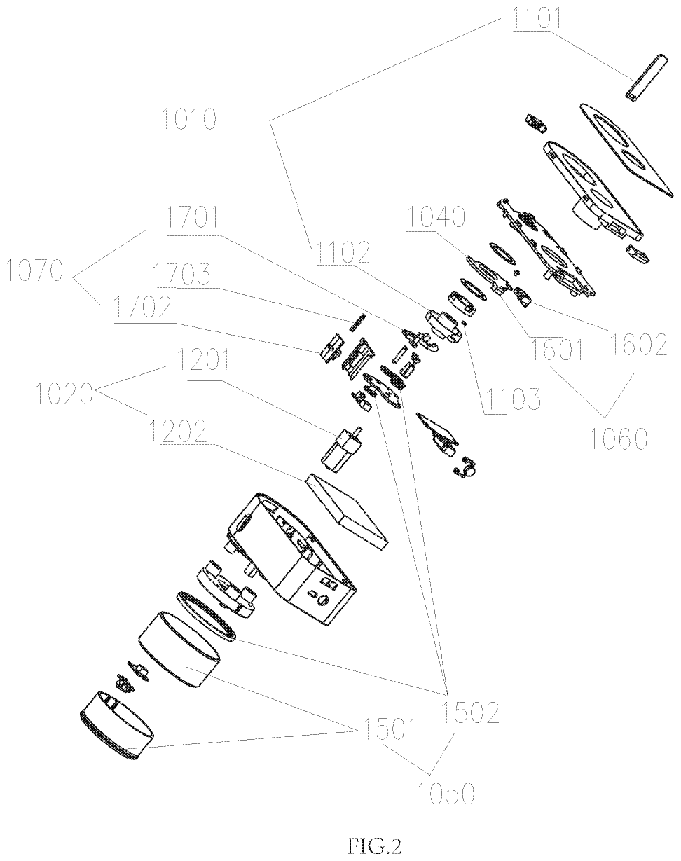

As an embodiment of the detection angle, as figured in FIG. 1 and FIG. 2, the present invention is disposed with a target position detection unit 4020 keeping still with respect to the rotating element 4010 (referring to the initial position indication unit 2060 in the second embodiment) and an induction unit 4030 linked to the internal key spindle 2101; when the internal key spindle 2101 is at the unlocking angle, the locking angle or the lock-up angle, the induction unit 4030 and the detection unit 4020 couple, the detection unit 4020 feedbacks the state information: unlocking state, locking state, or lock-up state.

In this embodiment, the detection unit 4020 comprises a pair of photoelectricity generation devices 2601 oppositely arranged, the motor shaft sleeve 2204 is disposed with a hem 2205 synchronously rotating with the internal key spindle 2101, the induction unit 4030 is disposed with a gap 2206 at the hem 2205; therein, the internal key spindle 2101 is fixed to the motor shaft sleeve 2204 and the hem 2205 extends outward from the periphery of the motor shaft sleeve 2204.

The hem 2205 is disposed between the photoelectricity generation devices 2601; when the internal key spindle 2101 is located at the locking angle and the unlocking angle, the gap 2206 is located at the optical path between the photoelectricity generation devices 2601; when no block is between the photoelectricity generation devices 2601, the detection unit 4020 feedbacks unlocking state or locking state; when the internal key spindle 2101 is located at the lock-up angle, the hem 2205 blocks the optical path of the photoelectricity generation devices 2601, when block exists between the photoelectricity generation devices 2601, the detection unit 4020 feedbacks lock-up state.

### INDUSTRIAL APPLICABILITY

Disclosed are a device of wireless controlling a lock and a method of preventing unlocking from the outer side. One end of the open unit is inserted to the lock hole of the door lock at the side facing the locked space and is at the initial position. The start unit is wireless connected to the driving unit, the start unit transmits control signal to make the driving unit drive the insert end of the open unit to rotate. The device and the method of the present invention is provided that the user can wireless open the door without a key. And the device is not only widely available for various door lock that the user needn't to change the door lock, but also prevents unlocking from the outer side.

1. A device of wireless controlling a lock, wherein comprising a main body, the main body comprises:
an open unit, one end of the open unit is inserted to a key hole at the side of the door lock faced to the locked space and is disposed at an initial position; the initial position is a position when the open unit is inserted to the key hole;
a driving unit, the driving unit is linked to the open unit to drive the insert end of the open unit to rotate in the key hole;
a start unit, the start unit is wireless connected to the driving unit, the start unit transmits control signal to make the driving unit drive the insert end of the open unit to rotate;
the insert end of the open unit rotates in clockwise direction or in counter-clockwise direction under the
driving of the driving unit.

2. The device of wireless controlling a lock according to claim 1, wherein further comprising a mechanical rotating unit and a motion record unit, the motion record unit records the forwardly rotating or backwardly rotating of the mechanical rotating unit to control the open unit to lock or unlock correspondingly by the driving unit.

3. The device of wireless controlling a lock according to claim 2, wherein the motion record unit comprises three Hall sensors arranged on the same plane and distributed of 120° and a magnet linked to the insert end of the open unit; when the insert end of the open unit rotates, the magnet faces to the three Hall sensors in order to make the sensors transmit sensing signals, recording the order of the Hall sensors transmitting sensing signals is recording the rotating trajectory of the insert end of the open unit.

4. The device of wireless controlling a lock according to claim 2, wherein the motion record unit comprises two Hall sensors and a magnet linked to the mechanical rotating unit; when the mechanical rotating unit is operated to drive the magnet to rotate, the motion record unit records which Hall sensor is conducted in different motions which are separately defined to be lock and unlock.

5. The device of wireless controlling a lock according to claim 3, wherein when the mechanical rotating unit is operated to drive the insert end of the open unit to rotate, the start unit records the order of the three Hall sensors transmitting sensing signals in different motions which are separately defined to be forwardly rotating and backwardly rotating.

6. The device of wireless controlling a lock according to claim 5, wherein the mechanical rotating unit comprises a hand wheel and a gear driving mechanism, the gear driving mechanism achieves the synchronously rotating of the insert end of the open unit and the hand wheel.

7. The device of wireless controlling a lock according to claim 5, wherein the insert end of the open unit rotates reversely to the initial position when rotating forwardly or backwardly to the end.

8. (canceled)

8. The device of wireless controlling a lock according to claim 1, wherein further comprising an initial position indication unit which indicates when the insert end of the open unit is located at the initial position.

9. The device of wireless controlling a lock according to claim 8, wherein the initial position indication unit comprises a photoelectricity generation device oppositely arranged, if no block is between the photoelectricity generation device, the photoelectricity generation device transmits an indication signal.

10. The device of wireless controlling a lock according to claim 9, wherein the edge of the open unit is disposed with a surrounding portion extending along the rotating shaft, the photoelectricity generation device is disposed at the interior and external sides of the surrounding portion; the surrounding portion is disposed with a gap; when the insert end of the open unit is not located at the initial position, the photoelectricity generation device is blocked by the surrounding portion; when the insert end of the open unit is located at the initial position, the photoelectricity generation device is connected by the gap.

11. The device of wireless controlling a lock according to claim 9, wherein the driving unit comprise a motor, a motor driving circuit and a power unit; an output shaft of the motor drives the open unit to rotate by a motor shaft sleeve; the front end of the motor shaft sleeve is disposed with a hem, the hem is disposed with two gaps faced to the shaft axis of the motor shaft sleeve and arranged at an angle of 180°; when the insert end of the open unit is not located at the initial position, the first photoelectricity generation device is blocked by the hem; when the insert end of the open unit is located at the initial position, the first photoelectricity generation device is connected by the gaps.

12. The device of wireless controlling a lock according to claim 10, wherein the initial position indication unit further comprises an initial position calibration mechanism; when the insert end of the open unit is located at the initial position, the initial position of the photoelectricity generation device is calibrated by the initial position calibration mechanism changing the position of the photoelectricity generation device relative to the gap until the photoelectricity generation device sends an indication signal out.

14. (canceled)

15. (canceled)

16. (canceled)

13. The device of wireless controlling a lock according to claim 12, wherein the open unit comprises a key spindle and a rotating plate coaxially rotatable; one end of the key spindle is the insert end, the other end is disposed with a first insert hole at the center of circle of the front side of the rotating plate; the surrounding portion is disposed at the edge of the rotating plate and is extending along the rotating shaft.

14. The device of wireless controlling a lock according to claim 13, wherein the driving unit comprises a motor, a motor control circuit and a power mechanism; the rotating shaft of the motor is inserted to a second insert hole at the center of circle at the back side of the rotating plate; the motor control circuit receives the control signal from the start unit to control the motor to rotate forwardly or reversely.

19. (canceled)

20. (canceled)

21. (canceled)

22. (canceled)

23. (canceled)

15. The device of wireless controlling a lock according to claim 1, wherein the open unit is an App installed in a personal smart device, and is wireless connected to the drive unit by Bluetooth or WiFi.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)
